(19) United States
(12) Patent Application Publication
(10) Pub. No.: US 2003/0138564 A1
(43) Pub. Date: Jul. 24, 2003

(54) Method of coloring straw and straw resulting therefrom

(76) Inventor: Virginia Stuckey, Knoxville, TN (US)

Correspondence Address: MICHAEL E. MCKEE, Attorney at Law, 804 Swaps Lane, Knoxville, TN, 37923, US

(21) Appl. No.: 10/054,089

(22) Filed: Jan. 22, 2002

(51) Int. Cl. B05D 1/18; B05D 5/00

(52) U.S. Cl. 427/372.2; 427/430.1

(57) ABSTRACT

A method of coloring straw for spreading over lawns or soil to reduce moisture loss from the lawns or soil includes the steps of providing an amount of straw, providing an amount of liquid coloring agent for coloring the straw to a desired color, and blending the straw with the amount of coloring agent. The straw is thereafter permitted to dry for subsequent spreading over the lawns or soil.

### BACKGROUND OF THE INVENTION

This invention relates generally to materials used for horticulture purposes and relates, more particularly, to fibrous material strewn across soil.

It is known that fibrous material, such as straw, can be advantageously strewn over selected areas of soil to help hold moisture in the soil and to help prevent soil erosion. Such areas where straw may be desired to be spread include areas around growing plants, such as garden-grown tomatoes, and areas where seeds have recently been sown.

In instances in which the appearance of lawns and landscapes is desired to be improved by cultivating an area of soil of the lawn or landscape and then sowing grass seed in the cultivated area, straw is commonly strewn across the soil following the sowing of the grass seed. However, for the sake of improving the appearance of the lawn or landscape after the grass has grown to a relatively advanced stage, the straw is commonly removed to thereby remove the color of the straw (which is naturally yellowish in color) from the lawn or landscape. It can be readily appreciated that if the color of the grass, when mature, is green, any yellowish color of straw remaining across the soil can detract (in an aesthetic sense) from the green color of the lawn or landscape.

It would be desirable to provide a straw which, after being spread over areas of soil in which grass seed has been sown, does not have to be removed from the area for the sake of improving the appearance of the lawn or landscape.

Another object of the present invention is to provide such a straw which bears the color of the grass being grown in the area.

Still another object of the present invention is to provide such a straw which is green in color.

Yet another object of the present invention is to provide a method of coloring straw.

A further object of the present invention is to provide such a method which is uncomplicated to perform yet is effective in results.

### SUMMARY OF THE INVENTION

This invention resides in a method for coloring straw and a straw which has been colored in accordance with the method of the invention.

The method includes the steps of providing an amount of straw, providing an amount of liquid coloring agent for coloring the straw to a desired color, and blending the straw with the amount of coloring agent. The straw is subsequently permitted to dry before being strewn across a lawn or soil.

### BRIEF DESCRIPTION OF THE DRAWINGS

FIG. 1 is a perspective view of an area of soil over which straw has been strewn.

FIG. 2 is a perspective view of an amount of straw to be colored by an embodiment of the method of the present invention.

FIGS. 3-5 are views illustrating sequential steps involved in the coloring of straw in accordance with an embodiment of the method of the present invention.

### DETAILED DESCRIPTION OF AN ILLUSTRATIVE EMBODIMENT

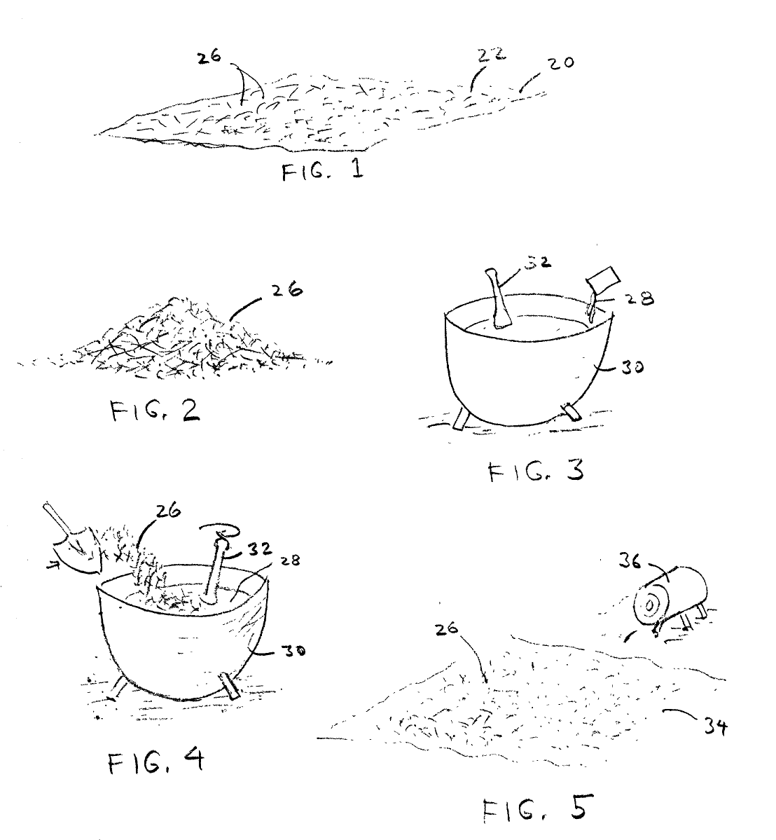

Turning now to the drawings in greater detail, there is illustrated in FIG. 1 a common environment in which straw is used. More specifically, the depicted FIG. 1 environment includes a lawn 20 having a cultivated area 22 of soil within which grass seed is sewn. To help prevent soil erosion and shade the soil of the area 22 to thereby limit the loss of moisture from the soil until the grass reaches an advanced state of growth, straw is commonly spread over the area 22 soon after the grass seed is sown in the soil.

In the example described herein, the color of the grass, when mature, sewn within the area 22 is green, and the straw to be strewn over the area 22 is also green. The green color of the straw can enhance the attractiveness of the lawn 20 while the grass grows in the area 22 and does not have to be later raked up and removed from the area 22 to remove the non-green color of the straw from the lawn 22.

Straw which has been commonly strewn over areas, such as the area 22 of the lawn 20, is not naturally green in color at least not when the straw is harvested for purposes described herein. In fact, straw commonly harvested for such purposes is wheat straw, although pine straw, rye straw and oat straw have also been used. Such straw is naturally yellow or gold (hereinafter yellowish) in color. Therefore, unless colored to the color (i.e. green) of the grass desired to be grown upon the lawn 20, straw strewn across the lawn will be visible—even after the grass is grown to a relatively advanced state of growth. Consequently, yellowish-colored straw which is strewn over a lawn, such as the lawn 20 of FIG. 1, is commonly raked up and removed when the grass reaches an advanced state of growth so that the yellowish color of the straw is not visible in the lawn 20.

Accordingly, it is a feature of the present invention to provide a method for coloring straw to the color green and to provide green-colored straw which has been colored in accordance with the method described herein.

To color straw and with reference to FIG. 2, an amount of straw 26 is provided and cut into small pieces so that no stem of the straw is longer than about two inches in length. To cut the straw 26 into pieces of the desired (small) size, a grinding machine (not shown) can be used.

Next and with reference to FIG. 3, an amount of liquid coloring agent 28 is provided and poured into a receptacle 30 within which the straw 26 is to be mixed and thereby blended with the coloring agent 28. Since the straw 26 to be colored with the liquid coloring agent 28 is intended to be spread across soil and could subsequently remain in the soil after the straw 26 disintegrates or rots, it is preferable that the liquid coloring agent 28 not be toxic or otherwise harmful to the soil. An example of a coloring agent 28 found to be non-toxic and harmless to the soil is green food coloring intended to be mixed with water to form a coloring solution and which is suitable for coloring food (and which is also mixed with water for coloring hard-boiled eggs).

An example of green food coloring suitable for use as the liquid coloring agent 28 is available from Speciality Brands, a division of Burns Philip Food Inc., San Francisco, Calif. under the trade designation “Durkee”. In accordance with the ingredients listed on the packaging of the aforedescribed Durkee product, green food coloring includes water, propylene glycol, artificial colors (e.g. FD&C Yellow #5 and Blue #1), and propylparaben (as a preservative).

When mixing with water for use, one or two 10.5 ounce bottle of green food coloring, such as the aforedescribed Durkee food coloring, is poured within the receptacle 30 and mixed with water in the receptacle 30 for every one bale of straw to be colored. Whether one bottle or two bottles are used will depend upon the shade of the grass color attempting to be matched. That is to say, to apply a deeper shade of green to the straw 26, two bottles of food coloring would be used. However and as will be apparent herein, the concentration of food coloring to water in the receptacle 30 can be altered. The food coloring can be stirred into the water with an appropriate stirring instrument 32 to provide the coloring solution within which the straw 26 is to be submerged and mixed.

With reference to FIG. 4, the straw 26 (which has been cut into small pieces) is then placed within the receptacle 30 and stirred, or blended, within the liquid coloring agent 28 so that the surfaces of the straw 26 are exposed to and colored by the liquid coloring agent 28. By cutting up the straw 26 into relatively small pieces, more surface area of the straw is exposed to the liquid coloring agent 28 during this mixing step. It has been found that the longer that the straw 26 is exposed to the liquid coloring agent 28, the greener that the straw 26 becomes. Therefore, if a long soaking time can be afforded, the liquid coloring agent 28 can contain a smaller ratio of food coloring to water.

Following a period of time sufficient for the straw 28 to become green in color, the straw 26 is removed from the receptacle 30 and permitted to dry. In the example depicted in FIG. 5, the straw 26 has been spread to dry in the air over a plastic sheet 34. If desired, the drying of the straw 26 can be facilitated with the use of a hot-air blower 36. Upon drying of the straw 26 to a completely dry condition, the straw 26 is ready to be spread upon the lawn 22 (FIG. 1).

It will be appreciated that when the green-colored straw 26 is strewn over freshly-cultivated (e.g. brown) soil, the straw 26 provides the soil with a green appearance. Moreover, if colored appropriately, the straw 26 will match the color of the grass growing around the perimeter of the soil. Therefore, if grass seed has been sown within the soil, the straw 26 will continue to render the soil green in color (and match the color of the grass surrounding the soil) until the straw 26 either rots or the grass becomes so tall that the straw is completely hidden from view. In either event, the straw 26 never has to be raked up and removed to remove any non-grass color from the soil. Thus, the straw 26 also saves labor which would otherwise have been required to rake up and remove the straw.

It will be understood that numerous modifications and substitutions can be had to the aforedescribed embodiments without departing from the spirit of the invention. For example, although the aforedescribed embodiment involves a description of coloring straw the color green, the present invention may be used to color straw any number of colors, such as blue-green or blue, to match the color of the mature grass being grown or to match the color of grass growing around the perimeter of the area across which the straw is to be strewn. Further still, although the aforedescribed method involves the cutting of the straw 26 into small pieces before the straw is placed within and blended with the liquid coloring agent 28, the step of cutting the straw into small pieces can be carried out after the straw has been colored with the coloring agent and subsequently dried.

Furthermore and although the straw 26 which has been colored in accordance with the discussion above has been described as being subsequently strewn over a lawn or soil in which grass seed has been sown, the straw 26 can be strew over other areas, such as along highways and freeways, to reduce erosion of the soil or moisture loss in the soil. Accordingly, the aforedescribed embodiments are intended for the purpose of illustration and not as limitation.

1. A method of coloring straw comprising the steps of:
providing an amount of straw;
providing an amount of liquid coloring agent for coloring the straw to a desired color;
blending the straw with the amount of coloring agent; and
permitting the straw to dry.

2. The method as defined in claim 1 wherein the liquid coloring agent possesses the color to which the straw is desired to be colored.

3. The method as defined in claim 2 wherein the color of the liquid coloring agent is green.

4. The method as defined in claim 2 wherein the liquid coloring agent is food coloring.

5. The method as defined in claim 1 wherein no straw in the amount of straw is longer than about two inches.

6. The method as defined in claim 1 wherein the step of blending is preceded by step of cutting up the straw so that no stem of the straw to be blended in the blending step is longer than about two inches in length.

7. The method as defined in claim 1 wherein the step of drying is followed by a step of cutting up the straw so that no stem of the straw is longer than about two inches in length.

8. The straw which has been colored in accordance with the method of claim 1.

9. A method for coloring straw which has been cut up so that no stem of the straw has a length in excess of about two inches, the method comprising the steps of:
providing a liquid coloring agent for coloring the straw to a desired color wherein the liquid coloring agent is sufficient in amount to permit the straw to be submerged within the liquid coloring agent;
submerging the straw within the liquid coloring agent so that the straw is colored by the liquid coloring agent;
removing the straw from the amount of liquid coloring agent; and
permitting the straw to dry.

10. A method as defined in claim 9 wherein the step of submerging including the steps of blending the straw with the liquid coloring agent.

11. The straw which has been colored in accordance with the method of claim 9.
